(19) United States
(12) Patent Application Publication
(10) Pub. No.: US 2012/0189052 A1
(43) Pub. Date: Jul. 26, 2012

(54) SIGNALING QUANTIZATION PARAMETER CHANGES FOR CODED UNITS IN HIGH EFFICIENCY VIDEO CODING (HEVC)

(75) Inventors: Marta Karczewicz, SAN DIEGO, CA (US); RAJAN L. JOSHI, SAN DIEGO, CA (US)

(73) Assignee: QUALCOMM INCORPORATED, San Diego, CA (US)

(21) Appl. No.: 13/252,600

(22) Filed: Oct. 4, 2011

Related U.S. Application Data
(60) Provisional application No. 61/435,750, filed on Jan. 24, 2011.

(51) Int. Cl. H04N 7/50

(52) U.S. Cl. 375/240.12; 375/E07.211

(57) ABSTRACT

In one example, this disclosure describes a method of decoding video data. The method comprises receiving a coding unit (CU) of encoded video data. The CU is partitioned into a set of block-sized coded units (CUs) according to a quadtree partitioning scheme, and decoding one or more syntax elements for the CU to indicate a change in a quantization parameter for the CU relative to a predicted quantization parameter for the CU only if the CU includes any non-zero transform coefficients. The one or more syntax elements are decoded from a position within the encoded video data after an indication that the CU will include at least some non-zero transform coefficients, and before the transform coefficients for the CU.

This application claims the benefit of U.S. Provisional Application No. 61/435,750, filed on Jan. 24, 2011, the entire content of which is incorporated herein by reference.

### TECHNICAL FIELD

This disclosure relates to video encoding techniques used to compress video data and, more particularly, video coding techniques consistent with the emerging high efficiency video coding (HEVC) standard.

### BACKGROUND

Digital video capabilities can be incorporated into a wide range of video devices, including digital televisions, digital direct broadcast systems, wireless communication devices such as wireless telephone handsets, wireless broadcast systems, personal digital assistants (PDAs), laptop or desktop computers, tablet computers, digital cameras, digital recording devices, video gaming devices, video game consoles, personal multimedia players, and the like. New video coding standards, such as the High Efficiency Video Coding (HEVC) standard being developed by the “Joint Collaborative Team—Video Coding” (JCTVC), which is a collaboration between MPEG and ITU-T, are being developed. The emerging HEVC standard is sometimes referred to as H.265.

### SUMMARY

This disclosure describes techniques for encoding syntax elements that define a quantization parameter (QP) associated with a video block, as defined in the emerging HEVC standard. In particular, consistent with the emerging HEVC standard, a video block may comprise a largest coding unit (LCU) that itself may be sub-divided into smaller coding units (CUs) according to a quadtree partitioning scheme, and possibly further partitioned into prediction units (PUs) for purposes of motion estimation and motion compensation. More specifically, this disclosure describes techniques for encoding changes (i.e., deltas) in a quantization parameter (i.e., the delta QP) for an LCU. In this case, the delta QP may define the change in the QP for the LCU relative to a predicted value of the QP for the LCU (e.g., where the predicted value may comprise the QP of a previous LCU of an encoded bitstream of video data). The delta QP may be determined, encoded and sent for every LCU (i.e., once per LCU), or possibly only for some specific types of LCUs. Nevertheless, although this disclosure is described primarily with respect to delta QP signaling at the LCU level, the techniques may also be applicable to cases where the delta QP is determined, encoded and sent for smaller CUs, e.g., CUs sized large enough that quantization changes are allowed and/or supported.

Even more specifically, this disclosure describes examples of the timing and placement associated with signaling delta QPs within an encoded bitstream, as well as timing associated with the decoding of delta QPs from the bitstream. For example, delta QPs may be encoded and signaled in a bitstream:
1) after it is determinable that a given LCU will include at least some non-zero transform coefficients, and
2) before the signaling of the non-zero transform coefficients.
   The decoder may decode the delta QPs in a similar manner, e.g., from a position within the encoded bitstream (i.e., a position within encoded video data) that occurs after indications or syntax elements that make it certain that a given LCU will include at least some non-zero transform coefficients, and before the transform coefficients, when non-zero transform coefficients are present.

In one example, this disclosure describes a method of decoding video data. The method comprises receiving a CU of encoded video data, wherein the CU is partitioned into a set of block-sized CUs according to a quadtree partitioning scheme, and decoding one or more syntax elements for the CU to indicate a change in a quantization parameter for the CU relative to a predicted quantization parameter for the CU only if the CU includes any non-zero transform coefficients. In particular, the one or more syntax elements are decoded from a position within the encoded video data after an indication that the CU will include at least some non-zero transform coefficients, and before the transform coefficients for the CU. The one or more syntax elements are not included with the CU if the CU does not include any non-zero transform coefficients.

In another example, this disclosure describes a method of encoding video data. The method comprises determining a change in a quantization parameter for a CU of encoded video data relative to a predicted quantization parameter for the CU, wherein the CU is partitioned into a set of block-sized CUs according to a quadtree partitioning scheme, and encoding one or more syntax elements for the CU to indicate the change in the quantization parameter only if the CU includes any non-zero transform coefficients. The one or more syntax elements are encoded in a bitstream after an indication that the CU will include at least some non-zero transform coefficients, and before the transform coefficients for the CU. Encoding the one or more syntax elements is avoided if the CU does not include any transform coefficients.

In another example, this disclosure describes video decoding device that decodes video data. The video decoding device comprises a video decoder that receives a CU of encoded video data, wherein the CU is partitioned into a set of block-sized CUs according to a quadtree partitioning scheme, and decodes one or more syntax elements for the CU to indicate a change in a quantization parameter for the CU relative to a predicted quantization parameter for the CU only if the CU includes any non-zero transform coefficients. The one or more syntax elements are decoded from a position within the encoded video data after an indication that the CU will include at least some non-zero transform coefficients, and before the transform coefficients for the CU. The one or more syntax elements are not included with the CU if the CU does not include any non-zero transform coefficients.

In another example, this disclosure describes a video encoding device that encodes video data. The video encoding device comprises a video encoder that determines a change in a quantization parameter for a CU of encoded video data relative to a predicted quantization parameter for the CU, wherein the CU is partitioned into a set of block-sized CUs according to a quadtree partitioning scheme, and encodes one or more syntax elements for the CU to indicate the change in the quantization parameter only if the CU includes any non-zero transform coefficients. The one or more syntax elements are encoded in a bitstream after an indication that the CU will include at least some non-zero transform coefficients, and before the transform coefficients for the CU. Encoding the one or more syntax elements is avoided if the CU does not include any transform coefficients.

In another example, this disclosure describe a device for decoding video data, the device comprising means for receiving a CU of encoded video data, wherein the CU is partitioned into a set of block-sized CUs according to a quadtree partitioning scheme, and means for decoding one or more syntax elements for the CU to indicate a change in a quantization parameter for the CU relative to a predicted quantization parameter for the CU only if the CU includes any non-zero transform coefficients. The one or more syntax elements are decoded from a position within the encoded video data after an indication that the CU will include at least some non-zero transform coefficients, and before the transform coefficients for the CU. The one or more syntax elements are not included with the CU if the CU does not include any non-zero transform coefficients.

In another example, this disclosure describes a device for encoding video data, the device comprising means for determining a change in a quantization parameter for a CU of encoded video data relative to a predicted quantization parameter for the CU, wherein the CU is partitioned into a set of block-sized CUs according to a quadtree partitioning scheme, and means for encoding one or more syntax elements for the CU to indicate the change in the quantization parameter only if the CU includes any non-zero transform coefficients. The one or more syntax elements are encoded in a bitstream after an indication that the CU will include at least some non-zero transform coefficients, and before the transform coefficients for the CU. The means for encoding avoids encoding the one or more syntax elements if the CU does not include any transform coefficients.

The techniques described in this disclosure may be implemented in hardware, software, firmware, or any combination thereof. For example, various techniques may be implemented or executed by one or more processors. As used herein, a processor may refer to a microprocessor, an application specific integrated circuit (ASIC), a field programmable gate array (FPGA), a digital signal processor (DSP), or other equivalent integrated or discrete logic circuitry. Software may be executed by one or more processors. Software comprising instructions to execute the techniques may be initially stored in a computer-readable medium and loaded and executed by a processor.

Accordingly, this disclosure also contemplates computer-readable storage media comprising instructions to cause a processor to perform any the techniques described in this disclosure. In some cases, the computer-readable storage medium may form part of a computer program storage product, which may be sold to manufacturers and/or used in a device. The computer program product may include the computer-readable medium, and in some cases, may also include packaging materials.

In one example, this disclosure describes a computer-readable medium comprising instructions that upon execution cause a processor to decode video data, wherein the instructions cause the processor to upon receiving a CU of encoded video data, wherein the CU is partitioned into a set of block-sized CUs according to a quadtree partitioning scheme, decode one or more syntax elements for the CU to indicate a change in a quantization parameter for the CU relative to a predicted quantization parameter for the CU only if the CU includes any non-zero transform coefficients. The one or more syntax elements are decoded from a position within the encoded video data after an indication that the CU will include at least some non-zero transform coefficients, and before the transform coefficients for the CU. The one or more syntax elements are not included with the CU if the CU does not include any non-zero transform coefficients.

In another example, this disclosure describes a computer-readable medium comprising instructions that upon execution cause a processor to encode video data, wherein the instructions cause the processor to determine a change in a quantization parameter for a CU of encoded video data relative to a predicted quantization parameter for the CU, wherein the CU is partitioned into a set of block-sized CUs according to a quadtree partitioning scheme, and encode one or more syntax elements for the CU to indicate the change in the quantization parameter only if the CU includes any non-zero transform coefficients. The one or more syntax elements are encoded in a bitstream after an indication that the CU will include at least some non-zero transform coefficients, and before the transform coefficients for the CU. The instructions cause the processor to avoid encoding the one or more syntax elements if the CU does not include any transform coefficients.

The details of one or more aspects of the disclosure are set forth in the accompanying drawings and the description below. Other features, objects, and advantages of the techniques described in this disclosure will be apparent from the description and drawings, and from the claims.

### BRIEF DESCRIPTION OF DRAWINGS

FIG. 1 is a block diagram illustrating a video encoding and decoding system that may implement one or more of the techniques of this disclosure.

FIG. 2 is a conceptual diagram illustrating quadtree partitioning of coded units (CUs) consistent with the techniques of this disclosure.

FIG. 3 is a block diagram illustrating a video encoder that may implement techniques of this disclosure.

FIG. 4 is a block diagram illustrating a video decoder that may implement techniques of this disclosure.

FIGS. 5-8 are flow diagrams illustrating techniques consistent with this disclosure.

### DETAILED DESCRIPTION

This disclosure describes techniques for encoding syntax elements that define a quantization parameter (QP) associated with a video block, as defined in the emerging HEVC standard currently under development, or similar standards. In particular, consistent with the emerging HEVC standard, a video block may comprise a largest coding unit (LCU) that itself may be sub-divided into smaller coding units (CUs) according to a quadtree partitioning scheme, and possibly further partitioned into prediction units (PUs) for purposes of motion estimation and motion compensation. More specifically, this disclosure describes techniques for encoding changes (i.e., deltas) in a quantization parameter (i.e., the delta QP) for an LCU (or some other CU sized large enough that quantization changes are supported). In this case, the delta QP may define the change in the QP for the LCU relative to a predicted value of the QP for the LCU. For example, the predicted QP value for the LCU may simply be the QP of a previous LCU (i.e., previously coded in the bitstream). Alternatively, the predicted QP value may be determined based on rules. For example, the rules may identify one or more other QP values of other LCUs or CUs, or average QP value that should be used.

The delta QP may be determined, encoded and sent for every LCU (i.e., once per LCU), or possibly only for some specific types of LCUs. Alternatively, the delta QP may be determined, encoded and sent for one or more smaller CUs of an LCU, e.g., CUs meeting some threshold minimum size, such as 8 by 8 CUs or another pre-defined minimum size. Thus, although the techniques are described primarily as relating to delta QP signaling at the LCU level, similar techniques could also apply with delta QP signaling at some CU level e.g., CUs sized large enough that quantization changes are allowed and/or supported. Also, although the techniques are described primarily as relating to HEVC, the techniques could similarly apply to other standards that use a video block partitioning scheme similar to that of HEVC.

Even more specifically, this disclosure concerns the timing associated with encoding and signaling delta QPs within a bitstream, as well as timing associated with the decoding of delta QPs. In particular, delta QPs may be signaled in the bitstream:
1) after syntax elements that allow for determinations of whether a given LCU will include at least some non-zero transform coefficients for the residual data, and
2) before the transform coefficients.
   Many aspects of disclosure are written with the assumption that the delta QP can be changed only at the LCU level. However, the same techniques can be extended to cases where delta QP can be signaled at CU level. In this case, there may be size restrictions such that only CUs that meet or exceed a particular size (e.g., 8 by 8 or larger) may be allowed to change the QP.

The decoder may decode the delta QPs in a similar manner, i.e., from a position in the encoded video data after indications that a given LCU will include at least some non-zero transform coefficients, and before the transform coefficients. The prediction mode used to encode CUs may indicate whether or not the coded unit can include transform coefficients. For example, some coding modes (such as SKIP mode) encode video blocks without including any residual information, which means that such video blocks cannot have any non-zero transform coefficients. In addition, for some coding modes, coded block flags (CBF) may comprise bit-flags that indicate whether transform units (TUs) within an LCU contain any residual data in the form of non-zero transform coefficients. If non-zero transform coefficients are present (as indicated by the CBFs), then a delta QP may be defined for the associated LCU. On the other hand, if no non-zero transform coefficients are present for an LCU (as indicated by one or more CBFs) then any encoding of the delta QP can be avoided for that LCU.

In some examples, this disclosure concerns the timing of the encoding and the timing of the decoding. However, in other examples, this disclosure concerns the positioning of the delta QP syntax elements within an encoded bitstream. Accordingly, this disclosure concerns the encoding of the bitstream so as to properly position the delta QP syntax elements within the bitstream as well as decoding techniques that decode the delta QP syntax elements from the proper position within encoded video data (i.e., the encoded bitstream).

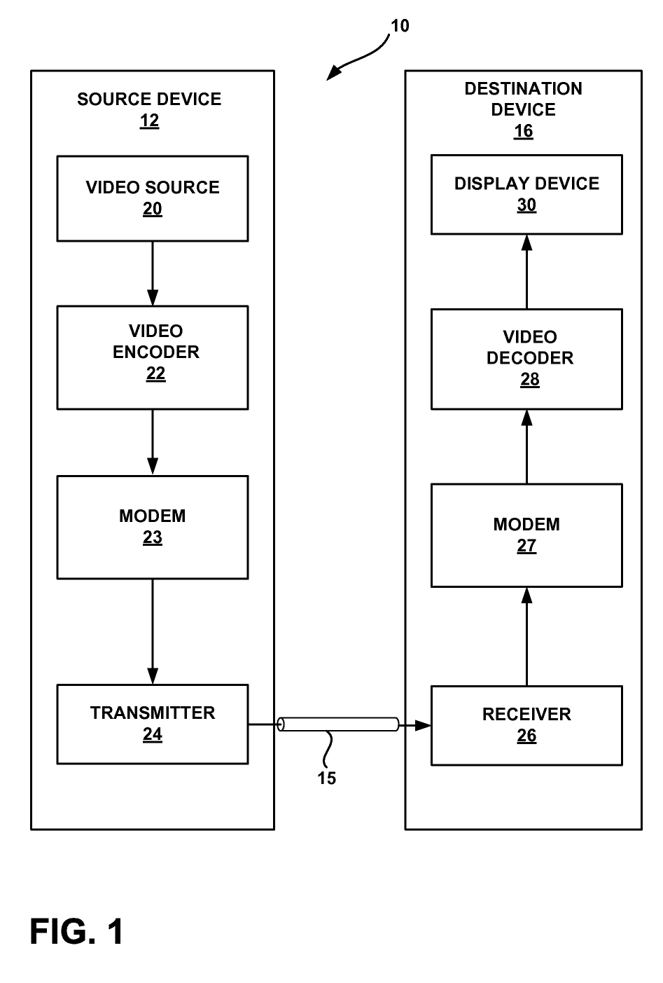

FIG. 1 is a block diagram illustrating an exemplary video encoding and decoding system 10 that may implement techniques of this disclosure. As shown in FIG. 1, system 10 includes a source device 12 that transmits encoded video to a destination device 16 via a communication channel 15. Source device 12 and destination device 16 may comprise any of a wide range of devices. In some cases, source device 12 and destination device 16 may comprise wireless communication device handsets, such as so-called cellular or satellite radiotelephones. The techniques of this disclosure, however, which apply generally to the encoding, decoding and communication of changes in a quantization parameter (i.e., a delta QP), are not necessarily limited to wireless applications or settings, and may be applied to non-wireless devices including video encoding and/or decoding capabilities. Source device 12 and destination device 16 are merely examples of coding devices that can support the techniques described herein.

In the example of FIG. 1, source device 12 may include a video source 20, a video encoder 22, a modulator/demodulator (modem) 23 and a transmitter 24. Destination device 16 may include a receiver 26, a modem 27, a video decoder 28, and a display device 30. In accordance with this disclosure, video encoder 22 of source device 12 may be configured to encode a delta QP for LCUs (or possibly CUs large enough to allow for quantization changes) during a video encoding process in order to communicate the level of quantization applied to quantized transform coefficients of the LCU. Syntax elements may be generated at video encoder 22 in order to signal the delta QP within an encoded bitstream. This disclosure recognizes that delta QP is generally irrelevant if the LCU does not have any non-zero transform coefficients. In such cases, encoding of the delta QP can be avoided altogether, thereby improving data compression.

Video encoder 22 of source device 12 may encode video data received from video source 20 using the techniques of this disclosure. Video source 20 may comprise a video capture device, such as a video camera, a video archive containing previously captured video, a video feed from a video content provider or another source of video. As a further alternative, video source 20 may generate computer graphics-based data as the source video, or a combination of live video, archived video, and computer-generated video. In some cases, if video source 20 is a video camera, source device 12 and destination device 16 may form so-called camera phones or video phones. In each case, the captured, pre-captured or computer-generated video may be encoded by video encoder 22. The techniques of this disclosure are equally applicable to any encoding or decoding device, such as server computers, digital direct broadcast systems, wireless broadcast systems, media players, digital televisions, desktop or laptop computers, tablet computers, handheld computers, gaming consoles, set-top boxes, wireless communication devices such as wireless telephone handsets, personal digital assistants (PDAs), digital cameras, digital recording devices, video gaming devices, personal multimedia players, or other devices that support video encoding, video decoding, or both. The techniques may be used in video streaming applications for encoding video at a source of the video streaming, decoding video at the destination of the video streaming, or both.

In the source to destination example of FIG. 1, once the video data is encoded by video encoder 22, the encoded video information may then be modulated by modem 23 according to a communication standard, e.g., such as code division multiple access (CDMA), orthogonal frequency division multiplexing (OFDM) or any other communication standard or technique. The encoded and modulated data can then be transmitted to destination device 16 via transmitter 24. Modem 23 may include various mixers, filters, amplifiers or other components designed for signal modulation. Transmitter 24 may include circuits designed for transmitting data, including amplifiers, filters, and one or more antennas. Receiver 26 of destination device 16 receives information over channel 15, and modem 27 demodulates the information. Again, the techniques are not limited to any requirements of data communication between devices, and can apply to encoding devices that encode and store data, or decoding devices that receive encoded video and decode the video data for presentation to a user.

The video decoding process performed by video decoder 28 may include reciprocal techniques to the encoding techniques performed by video encoder 22. In particular, video decoder 28 may decode one or more syntax elements for an LCU to indicate a change (delta) in a QP for the LCU relative to a predicted value for the QP for the LCU only if the LCU includes at least some non-zero transform coefficients. In this case, decoding the one or more syntax elements occurs from a position with the encoded video data that occurs after an indication that the LCU will include at least some non-zero transform coefficients, and before the transform coefficients for the LCU. The one or more syntax elements that indicate the delta QP are not included with the LCU if the LCU does not include any non-zero transform coefficients.

Communication channel 15 may comprise any wireless or wired communication medium, such as a radio frequency (RF) spectrum or one or more physical transmission lines, or any combination of wireless and wired media. Communication channel 15 may form part of a packet-based network, such as a local area network, a wide-area network, or a global network such as the Internet. Communication channel 15 generally represents any suitable communication medium, or collection of different communication media, for transmitting video data from source device 12 to destination device 16.

Video encoder 22 and video decoder 28 may operate substantially according to a video compression standard such as the emerging HEVC standard currently under development. However, the techniques of this disclosure may also be applied in the context of a variety of other video coding standards, including some old standards, or new or emerging standards.

Although not shown in FIG. 1, in some cases, video encoder 22 and video decoder 28 may each be integrated with an audio encoder and decoder, and may include appropriate MUX-DEMUX units, or other hardware and software, to handle encoding of both audio and video in a common data stream or separate data streams. If applicable, MUX-DEMUX units may conform to the ITU H.223 multiplexer protocol, or other protocols such as the user datagram protocol (UDP).

Video encoder 22 and video decoder 28 each may be implemented as one or more microprocessors, digital signal processors (DSPs), application specific integrated circuits (ASICs), field programmable gate arrays (FPGAs), discrete logic, software, hardware, firmware or combinations thereof. Each of video encoder 22 and video decoder 28 may be included in one or more encoders or decoders, either of which may be integrated as part of a combined encoder/decoder (CODEC) in a respective mobile device, subscriber device, broadcast device, server, or the like. In this disclosure, the term coder refers to an encoder, a decoder, or CODEC, and the terms coder, encoder, decoder and CODEC all refer to specific machines designed for the coding (encoding and/or decoding) of video data consistent with this disclosure.

In some cases, devices 12, 16 may operate in a substantially symmetrical manner. For example, each of devices 12, 16 may include video encoding and decoding components. Hence, system 10 may support one-way or two-way video transmission between video devices 12, 16, e.g., for video streaming, video playback, video broadcasting, or video telephony.

During the encoding process, video encoder 22 may execute a number of coding techniques or operations. In general, video encoder 22 operates on blocks of video data consistent with the HEVC standard. Consistent with HEVC, the video blocks are referred to as coded units (CUs) and many CUs exist within individual video frames (or other independently defined units of video such as slices). Frames, slices, portions of frames, groups of pictures, or other data structures may be defined as units of video information that include a plurality of CUs. The CUs may have varying sizes consistent with the HEVC standard, and the bitstream may define largest coded units (LCUs) as the largest size of CU. The delta QP signaling may occur in syntax elements associated with LCUs, although this disclosure also contemplates delta QP signaling at the CU level, e.g., CUs that meet or exceed some threshold size requirement for which quantization is adjustable.

With the HEVC standard, LCUs may be divided into smaller and smaller CUs according to a quadtree partitioning scheme, and the different CUs that are defined in the scheme may be further partitioned into so-called prediction units (PUs). The LCUs, CUs, and PUs are all video blocks within the meaning of this disclosure. Other types of video blocks may also be used, consistent with the HEVC standard.

Video encoder 22 may perform predictive coding in which a video block being coded (e.g., a PU of a CU within an LCU) is compared to one or more predictive candidates in order to identify a predictive block. This process of predictive coding may be intra (in which case the predictive data is generated based on neighboring intra data within the same video frame or slice) or inter (in which case the predictive data is generated based on video data in previous or subsequent frames or slices).

After generating the predictive block, the differences between the current video block being coded and the predictive block are coded as a residual block, and prediction syntax (such as a motion vector in the case of inter coding, or a predictive mode in the case of intra coding) is used to identify the predictive block. Residual samples corresponding to a CU may be subdivided into smaller units using a quadtree structure known as “residual quad tree” (RQT). The leaf nodes of the RQT may be referred as transform units (TUs). The TUs are may be transformed and quantized. Transform techniques may comprise a DCT process or conceptually similar process, integer transforms, wavelet transforms, or other types of transforms. In a DCT process, as an example, the transform process converts a set of pixel values (e.g., residual values) into transform coefficients, which may represent the energy of the pixel values in the frequency domain.

Quantization may be applied to the transform coefficients, and generally involves a process that limits the number of bits associated with any given transform coefficient. More specifically, quantization may be applied according to a quantization parameter (QP) defined at the LCU level. Accordingly, the same level of quantization may be applied to all transform coefficients in the TUs of CUs within an LCU. However, rather than signal the QP itself, a change (i.e., a delta) in the QP may be signaled with the LCU. The delta QP defines a change in the quantization parameter for the LCU relative to a predicted value for the QP for the LCU, such as the QP of a previously communicated LCU or a QP defined by previous QPs and/or one or more rules. This disclosure concerns the timing of signaling the delta QP within an encoded bitstream (e.g., after indications that residual data will be present), and the techniques can eliminate signaling of the delta QP in cases where non-zero transform coefficients are not included for a given LCU, which can improve compression in the HEVC standard.

Following transform and quantization, entropy coding may be performed on the quantized and transformed residual video blocks. Syntax elements, such as the delta QPs, prediction vectors, coding modes, filters, offsets, or other information, may also be included in the entropy coded bitstream. In general, entropy coding comprises one or more processes that collectively compress a sequence of quantized transform coefficients and/or other syntax information. Scanning techniques may be performed on the quantized transform coefficients in order to define one or more serialized one-dimensional vectors of coefficients from two-dimensional video blocks. The scanned coefficients are then entropy coded along with any syntax information, e.g., via content adaptive variable length coding (CAVLC), context adaptive binary arithmetic coding (CABAC), or another entropy coding process.

As part of the encoding process, encoded video blocks may be decoded in order to generate the video data that is used for subsequent prediction-based coding of subsequent video blocks. This is often referred to as a decoding loop of the encoding process, and generally mimics the decoding that is performed by a decoder device. In the decoding loop of an encoder or a decoder, filtering techniques may be used to improve video quality, and e.g., smooth pixel boundaries and possibly remove artifacts from decoded video. This filtering may be in-loop or post-loop. With in-loop filtering, the filtering of reconstructed video data occurs in the coding loop, which means that the filtered data is stored by an encoder or a decoder for subsequent use in the prediction of subsequent image data. In contrast, with post-loop filtering the filtering of reconstructed video data occurs out of the coding loop, which means that unfiltered versions of the data are stored by an encoder or a decoder for subsequent use in the prediction of subsequent image data. The loop filtering often follows a separate deblock filtering process, which typically applies filtering to pixels that are on or near boundaries of adjacent video blocks in order to remove blockiness artifacts that manifest at video block boundaries.

There are at least two scenarios where the absence of any non-zero transform coefficients can be determined for a CU prior to the stage in which encoding of the transform coefficients would occur. As one example, the presence of residual data (e.g., the presence of non-zero transform coefficients in TUs) in CUs within an LCU can be identified by coded block flags (CBFs). CBFs are essentially indicators (such as one-bit flags) that identify whether any residual data (e.g., non-zero transform coefficients in TUs) exist for CUs. In this case, if CBFs for an LCU indicate that none of the CUs have any residual data, then quantization is irrelevant. Accordingly, in this case, encoding and signaling any delta QP for that LCU can be avoided altogether. The decoder can be programmed to know that if CBFs for an LCU indicate that none of the CUs have any non-zero transform coefficients, then the bitstream will not include any delta QP for that LCU. Thus, the one or more syntax elements that define the delta QP may be positioned in the encoded video data (i.e., the encoded bitstream) after one or more CBFs.

Another scenario where the absence of any non-zero transform coefficients can be determined for a CU prior to the stage in which encoding of the transform coefficients would occur is the case where the coding mode of the CU defines the CU as lacking any residual data. One example of this scenario is the so-called SKIP mode. For example, coding modes (such as SKIP, MERGE SKIP, or other similar modes), may not include any residual data, whatsoever. In such a case there is no need to include delta QP information for that CU because the CU would lack any non-zero transform coefficients that would be affected by quantization. Thus, the one or more syntax elements that define the delta QP, if present, may be positioned in the encoded video data (i.e., the encoded bitstream) after one or more syntax elements that define encoding modes used for the given CU.

Again, the emerging HEVC standard, which is currently under development, introduces new terms and block sizes for video blocks. In particular, HEVC refers to coding units (CUs), which can be partitioned according to a quadtree partitioning scheme. An “LCU” refers to the largest sized coding unit (e.g., the “largest coding unit”) supported in a given situation. The LCU size may itself be signaled as part of the bitstream, e.g., as sequence level syntax. The LCU can be partitioned into smaller CUs. The CUs may be partitioned into PUs for purposes of prediction. The PUs may have square or rectangular shapes. Transforms are not fixed in the emerging HEVC standard, but are defined according to TU sizes, which may be the same size as a given CU, or possibly smaller. The split of the residual data corresponding to a CU into TUs is controlled by the RQT as mentioned above.

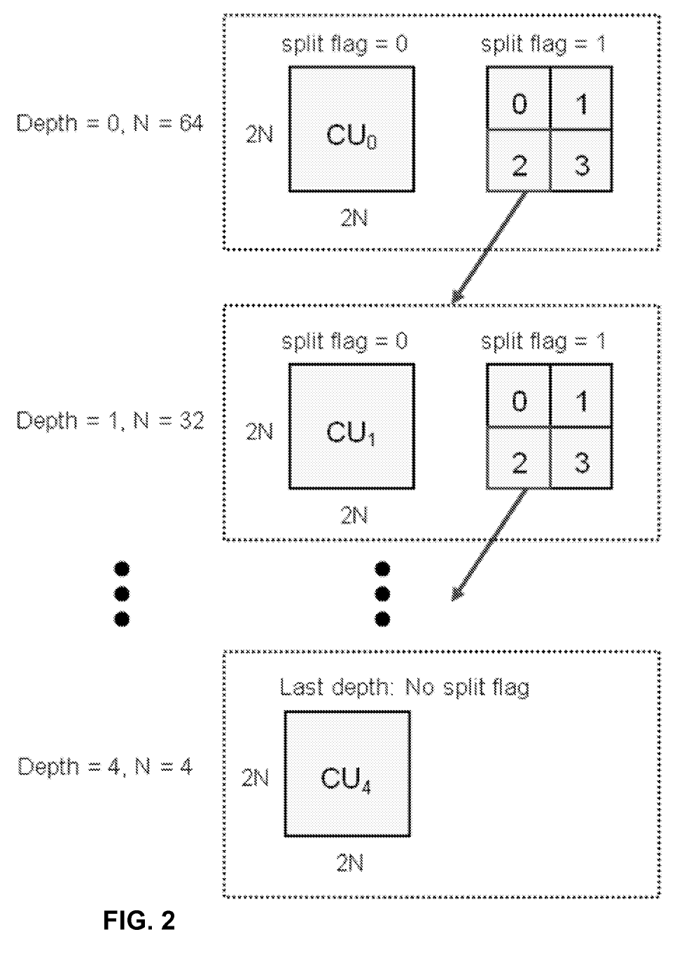

To illustrate video blocks according to the HEVC standard, FIG. 2 conceptually shows an LCU of depth 64 by 64, which is then partitioned into smaller CUs according to a quadtree partitioning scheme. Elements called “split flags” may be included as CU-level syntax to indicate whether any given CU is itself sub-divided into four more CUs. In FIG. 2, CU₀ may comprise the LCU, CU₁ through CU₄ may comprise sub-CUs of the LCU.

Again, coded block flags (CBFs) may be defined for an LCU in order to indicate whether any given CU includes non-zero transform coefficients. If the CBFs for a given LCU indicate that one or more CUs do not include any non-zero transform coefficients, then it is unnecessary to send any transform coefficients for that CU. Moreover, consistent with this disclosure, it is also unnecessary to send any delta QP for the LCU when the CBFs indicate that the LCU lacks transform coefficients. Also, if the coding mode for the CUs (or a combination of the coding modes and the CBFs indicate that a given LCU lacks any non-zero transform coefficients, then it may be unnecessary to encode, send or decode any delta QP for the LCU. This elimination of delta QP signaling, in such cases, can improve data compression consistent with the emerging HEVC standard.

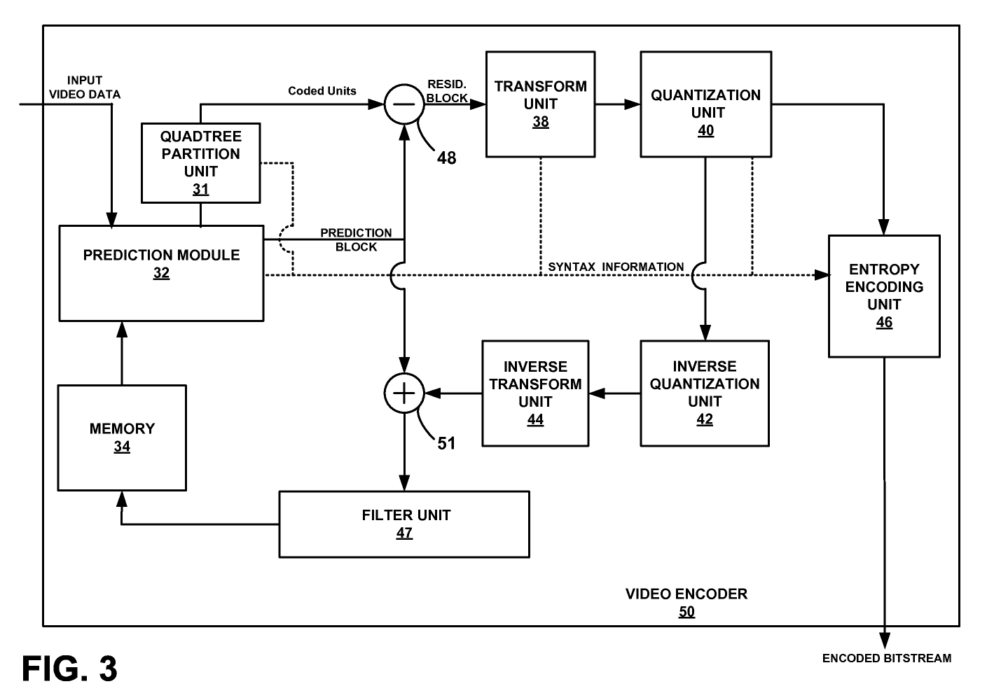

FIG. 3 is a block diagram illustrating a video encoder 50 consistent with this disclosure. Video encoder 50 may correspond to video encoder 22 of device 20, or a video encoder of a different device. As shown in FIG. 3, video encoder 50 includes a prediction module 32 quadtree partition unit 31, adders 48 and 51, and a memory 34. Video encoder 50 also includes a transform unit 38 and a quantization unit 40, as well as an inverse quantization unit 42 and an inverse transform unit 44. Video encoder 50 also includes an entropy coding unit 46, and a filter unit 47, which may include deblock filters and post loop and/or in loop filters. The encoded video data and syntax information that defines the manner of the encoding may be communicated to entropy encoding unit 46, which performs entropy encoding on the bitstream.

Prediction module 32 may operate in conjunction with quadtree partition unit 31 and quantization unit 40 so as to define and signal any changes (delta's) in the quantization parameter (QP). Quantization unit 40 may apply the QP (e.g., as defined by the delta QP and a predicted QP) to transformed residual samples, if such samples are present. However, in some cases, no residual data may exist for an entire LCU. In such cases, delta QP signaling can be avoided for that LCU.

In accordance with this disclosure, video encoder 50 may determine a change in a quantization parameter for an LCU of encoded video data relative to a predicted QP for the LCU. The predicted QP, for example, may comprise the QP of a previous LCU or may be based on more rules. The LCU and the previous LCU may each be partitioned into a set of block-sized coded units CUs according to a quadtree partitioning scheme. Video encoder 50 may encode one or more syntax elements for the LCU to indicate the change in the quantization parameter for a given LCU only if that LCU includes at least some non-zero transform coefficients, wherein encoding the one or more syntax elements occurs after determining that the LCU will include at least some non-zero transform coefficients, and before encoding the transform coefficients for the LCU. Moreover, video encoder 50 may avoid encoding the one or more syntax elements if the LCU does not include any transform coefficients. Accordingly, the one or more syntax elements may be encoded in the bitstream after an indication that the LCU will include at least some non-zero transform coefficients, and before the transform coefficients for the LCU.

The delta QP signaling may occur at the LCU level, or possibly another syntax layer such as for a group of LCUs or for a CU within an LCU. For example, in another example, delta QP may be signaled at a CU size of 8×8 or larger. The CU size at which delta QP can be signaled may by defined by the video coding standard being used. In any case, according to this disclosure, delta QPs may be encoded into the bitstream only after it is certain that a given LCU (or CU) will include at least some non-zero transform coefficients (e.g., non-zero residual data), and before the transform coefficients. In this way, if an LCU lacks residual data (such as for SKIP mode video blocks, or blocks in which the CBFs indicate that no non-zero transform coefficients exist), encoding of delta QP can be avoided to improve data compression.

Generally, during the encoding process, video encoder 50 receives input video data. Prediction module 32 performs predictive coding techniques on video blocks (e.g. CUs and PUs). Quadtree partition unit 31 may break an LCU into smaller CU's and PU's according to HEVC partitioning explained above with reference to FIG. 2. For inter coding, prediction module 32 compares CUs or PUs to various predictive candidates in one or more video reference frames or slices (e.g., one or more “list” of reference data) in order to define a predictive block. For intra coding, prediction module 32 generates a predictive block based on neighboring data within the same video frame or slice. Prediction module 32 outputs the prediction block and adder 48 subtracts the prediction block from the CU or PU being coded in order to generate a residual block. A residual block corresponding to a CU may be further subdivided into TUs using a residual quad tree (RQT) structure.

For inter coding, prediction module 32 may comprise motion estimation and motion compensation units that identify a motion vector that points to a prediction block and generates the prediction block based on the motion vector. Typically, motion estimation is considered the process of generating the motion vector, which estimates motion. For example, the motion vector may indicate the displacement of a predictive block within a predictive frame relative to the current block being coded within the current frame. Motion compensation is typically considered the process of fetching or generating the predictive block based on the motion vector determined by motion estimation. In some cases, motion compensation for inter-coding may include interpolations to sub-pixel resolution, which permits the motion estimation process to estimate motion of video blocks to such sub-pixel resolution.

After prediction module 32 outputs the prediction block, and after adder 48 subtracts the prediction block from the video block being coded in order to generate a residual block, transform unit 38 applies a transform to the residual block. The residual samples corresponding to a CU are partitioned further into TUs of various sizes using an RQT structure. The transform may comprise a discrete cosine transform (DCT) or a conceptually similar transform such as that defined by the ITU H.264 standard or the HEVC standard. So-called “butterfly” structures may be defined to perform the transforms, or matrix-based multiplication could also be used. Wavelet transforms, integer transforms, sub-band transforms or other types of transforms could also be used. In any case, transform unit applies the transform to the residual block, producing a block of residual transform coefficients. The transform, in general, may convert the residual information from a pixel domain to a frequency domain.

Quantization unit 40 then quantizes the residual transform coefficients to further reduce bit rate. Quantization unit 40, for example, may limit the number of bits used to code each of the coefficients. In particular, quantization unit 40 may apply the delta QP selected for the LCU so as to define the level of quantization to apply (such as by combining the delta QP with the QP of the previous LCU or some other known QP). After quantization is performed on transform coefficients, entropy coding unit 46 may scan and entropy encode the data.

CAVLC is one type of entropy coding technique supported by the ITU H.264 standard and the emerging HEVC standard, which may be applied on a vectorized basis by entropy coding unit 46. CAVLC uses variable length coding (VLC) tables in a manner that effectively compresses serialized “runs” of coefficients and/or syntax elements. CABAC is another type of entropy coding technique supported by the ITU H.264 standard or the HEVC standard, which may be applied on a vectorized basis by entropy coding unit 46. CABAC may involve several stages, including binarization, context model selection, and binary arithmetic coding. In this case, entropy coding unit 46 codes coefficients and syntax elements according to CABAC. Many other types of entropy coding techniques also exist, and new entropy coding techniques will likely emerge in the future. This disclosure is not limited to any specific entropy coding technique.

Following the entropy coding by entropy encoding unit 46, the encoded video may be transmitted to another device or archived for later transmission or retrieval. Again, the encoded video may comprise the entropy coded vectors and various syntax information (including the syntax information that defines delta QP for LCUs). Such information can be used by the decoder to properly configure the decoding process. Inverse quantization unit 42 and inverse transform unit 44 apply inverse quantization and inverse transform, respectively, to reconstruct the residual block in the pixel domain. Summer 51 adds the reconstructed residual block to the prediction block produced by prediction module 32 to produce a reconstructed video block for storage in memory 34. Prior to such storage, however, filter unit 47 may apply filtering to the video block to improve video quality. The filtering applied by filter unit 47 may reduce artifacts and smooth pixel boundaries. Moreover, filtering may improve compression by generating predictive video blocks that comprise close matches to video blocks being coded.

According to this disclosure, delta QP syntax information is only included for an LCU if the LCU includes at least some non-zero transform coefficients. If not, then the delta QP syntax information can be eliminated from the bitstream for that LCU. Again, there are at least two scenarios where prediction module 32 and quadtree partition unit 31 may determine and signal that the LCU does not include any non-zero transform coefficients.

As one example, the presence of non-zero residual data (e.g., the presence of non-zero transform coefficients in TUs) in CUs within an LCU can be identified by CBFs. Again, CBFs are essentially indicators (such as one-bit flags) that identify whether any non-zero transform coefficients in TUs exist for CUs. In this case, if CBFs encoded for an LCU indicate that none of the CUs have any residual data (e.g., none of the CUs within the LCU have any non-zero transform coefficients), then quantization is irrelevant. Accordingly, in this case, encoding and signaling any delta QP for that LCU can be avoided altogether.

Another scenario where the absence of any non-zero transform coefficients can be determined for an LCU prior to the stage in which encoding of the transform coefficients occurs is the case where the coding mode of the LCU defines the LCU as lacking any residual data. One example of this scenario is the so-called SKIP mode. For example, coding modes (such as SKIP mode), may not include any residual data, whatsoever, and therefore lacks non-zero transform coefficients. Thus, if quadtree partition unit 31 partitions an entire LCU into one block and prediction module 32 implements the SKIP mode for that entire LCU, any delta QP can be eliminated from the bitstream for that LCU. In this case, the data for a given LCU may be inherited or adopted from data from another LCU (such as the co-located LCU of the previous video frame). Since no residual data is included for that LCU, video encoder (e.g., quadtree partition unit 31 and/or prediction module 32) can avoid encoding and signaling any delta QP for that LCU.

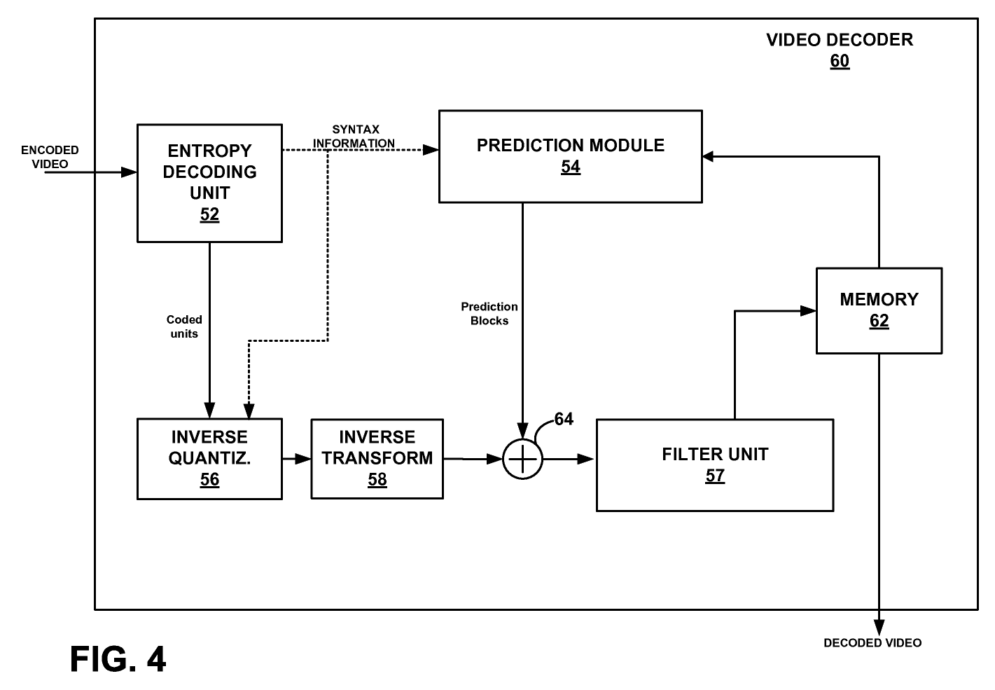

FIG. 4 is a block diagram illustrating an example of a video decoder 60, which decodes a video sequence that is encoded in the manner described herein. The techniques of this disclosure may be performed by video decoder 60 in some examples. In particular, video decoder 60 receives an LCU of encoded video data, wherein the LCU is partitioned into a set of block-sized CUs according to a quadtree partitioning scheme, and decodes one or more syntax elements for the LCU to indicate a change in a quantization parameter for the LCU relative to a predicted quantization parameter for that LCU, only if the LCU includes at least some non-zero transform coefficients. Thus, video decoder 60 decodes the one or more syntax elements after decoding an indication that the LCU will include at least some non-zero transform coefficients, and before decoding the transform coefficients for the LCU. The one or more syntax elements are not included with the LCU if the LCU does not include any non-zero transform coefficients. The bitstream itself may likewise reflect this ordering of the syntax elements. That is, the one or more syntax elements may be decoded from a position within the encoded video data after an indication that the CU will include at least some non-zero transform coefficients, and before the transform coefficients for the CU. The decoder may be configured to know where the various syntax elements are expected in the bitstream.

A video sequence received at video decoder 60 may comprise an encoded set of image frames, a set of frame slices, a commonly coded group of pictures (GOPs), or a wide variety of units of video information that include encoded LCUs and syntax information to define how to decode such LCUs. The process of decoding the LCUs may include decoding a delta QP, but only following a determination that a given LCU actually includes non-zero transform coefficients (and not before). If the given LCU does not include non-zero transform coefficients, then the LCU syntax data does not include any delta QP since quantization is irrelevant without the presence of non-zero transform coefficients. Again, the encoded video data (i.e., the bitstream itself) may likewise reflect this ordering of the syntax elements. That is, the one or more syntax elements may be decoded from a position within the encoded video data after an indication that the CU will include at least some non-zero transform coefficients, and before the transform coefficients for the CU. As mentioned, the decoder may be configured to know where the various syntax elements are expected in the bitstream.

Video decoder 60 includes an entropy decoding unit 52, which performs the reciprocal decoding function of the encoding performed by entropy encoding unit 46 of FIG. 2. In particular, entropy decoding unit 52 may perform CAVLC or CABAC decoding, or any other type of entropy decoding used by video encoder 50. Video decoder 60 also includes a prediction module 54, an inverse quantization unit 56, an inverse transform unit 58, a memory 62, and a summer 64. In particular, like video encoder 50, video decoder 60 includes a prediction module 54 and a filter unit 57. Prediction module 54 of video decoder 60 may include motion compensation elements and possibly one or more interpolation filters for sub-pixel interpolation in the motion compensation process. Filter unit 57 may filter the output of summer 64, and may receive entropy decoded filter information so as to define the filter coefficients applied in the loop filtering.

Upon receiving encoded video data, entropy decoding unit 52 performs reciprocal decoding to the encoding performed by entropy encoding unit 46 (of encoder 50 in FIG. 3). At the decoder, entropy decoding unit 52 parses the bitstream to determine LCU's and the corresponding partitioning associated with the LCU's. In some examples, any LCU may include a delta QP, but only if that LCU includes non-zero transform coefficients. Accordingly, entropy decoding unit 52 may forward the delta QP to inverse quantization unit 56, when the delta QP exists. Such decoding of the delta QP (e.g., by quadtree partitioning unit 53) occurs from a position in the encoded video data that occurs after an indication that the LCU will include at least some non-zero transform coefficients, and before the transform coefficients for the LCU. In this way, if the LCU does not include any non-zero transform coefficients (such as because the LCU is encoded in SKIP mode or because the CBFs of that LCU indicate that no residual data exists), then decoding of the delta QP is not needed or performed because no delta QP is included for that LCU.

Again, this disclosure concerns the timing associated with encoding, signaling and decoding delta QPs. Furthermore, this disclosure concerns the ordering of the syntax elements within the bitstream. In particular, delta QPs may be encoded and signaled in a bitstream (and therefore received and decoded):
1) after it is certain that a given LCU will include at least some non-zero transform coefficients, and
2) before the signaling (or before encoding or before decoding) of the transform coefficients.
   In the test model of the emerging HEVC standard, delta QPs are sent for any LCUs that include non-zero transform coefficients. Indeed, many video coding modes support the encoding of residual data (i.e., coefficients that represent the residual differences between pixels in a video block that is being coded and a prediction block, which may be identified by a motion vector or an intra coding mode). However, some coding modes (such as SKIP mode) do not allow for residual data.

Furthermore, as explained above, sometimes LCUs may lack residual data regardless of the coding mode. For example, it is possible that any type of LCU (such as one encoded in a standard bi-directional manner) may not include any residual data, and thus may not include any non-zero transform coefficients. For example, if a motion vector for a video block identifies predictive data that is identical to the current video block being coded, then residual data may not be generated in the predictive coding process. For every LCU, coded block flags (CBFs) may be encoded to indicate whether non-zero transform coefficients are included in the bitstream for each CU within the LCU. The CBFs may also indicate whether any non-zero transform coefficients exist in the luminance domain and/or the chrominance domain for blocks of a given LCU.

Encoding and signaling delta QPs after the final block of residual coefficients of an LCU can also create problems for parallel decoding of the different CUs of an LCU. This is because the quantization parameter may have changed for the LCU, but the decoder does not know whether or not the quantization parameter changed until after all of the transform coefficients of the LCU have been received at the decoder. For these and other reasons, this disclosure proposes that delta QPs should be encoded and signaled in a bitstream for LCUs:
1) after it is certain that a given LCU will include at least some non-zero transform coefficients, and
2) before the encoding and signaling of the transform coefficients in the bitstream.
   In some examples, this means that delta QPs are sent in the bitstream after the coded block flags (CBFs) for an LCU, but before any transform coefficients (provided that the CBFs indicate that there is at least one non-zero coefficient present). In such case, the delta QP is sent as soon as one CBF indicating the presence of non-zero transform coefficients is sent for an LCU, but before any remaining CBFs are sent for that LCU.

In short, placing delta QP at the end of an LCU can introduce delay in decoding, and if delta QP information is included at the beginning of the LCU, there may be cases where delta QP is unnecessarily signaled, such as when an LCU is partitioned into one SKIP CU, multiple SKIP CU's or when CBFs indicates that the LCU does not include any non-zero transform coefficinets. Therefore, in order to reduce the decoder delay as well as save on unnecessary delta QP signaling, this disclosure performs delta QP signaling within an encoded bitstream:
1) after it is certain that a given LCU will include at least some non-zero transform coefficients, and
2) before the signaling of the transform coefficients in the bitstream.
   In an alternative example, the delta QP signaling may take place after the first CU with non-zero transform coefficients (e.g., after one or more TUs of the first CU within an LCU).

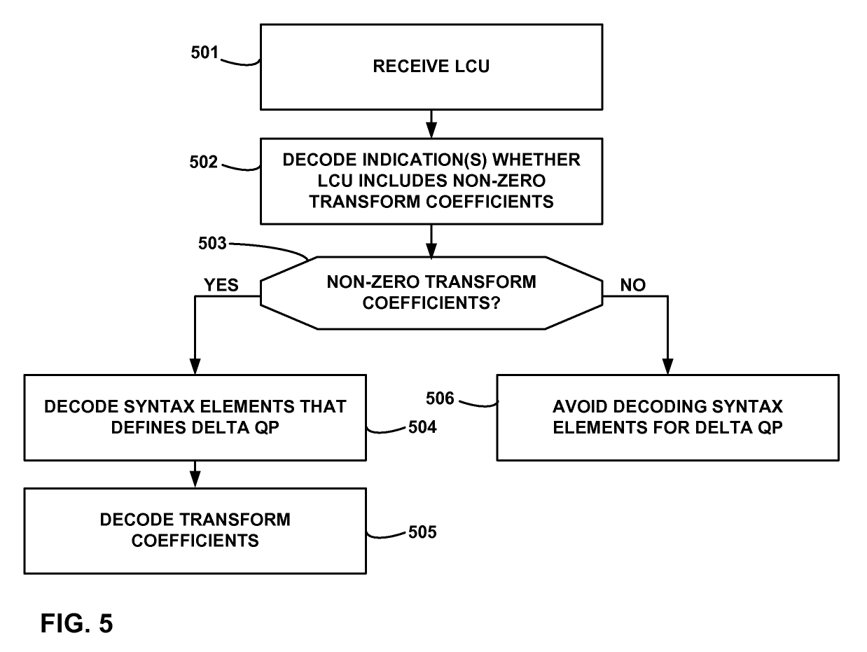

FIG. 5 is a flow diagram illustrating a decoding technique consistent with this disclosure. FIG. 5 will be described from the perspective of video decoder 60 of FIG. 4, although other devices may perform similar techniques. As shown in FIG. 5, entropy decoding unit 52 receives an LCU (501), and decodes one or more indications of whether the LCU includes non-zero transform coefficients (502). Again, two examples of these indications are the CBFs and the coding mode. If the CBFs indicate that no non-zero transform coefficients exist or if the coding mode is a mode that lacks transform coefficients, then entropy decoding unit 52 can be configured to know that a delta QP is not included for that LCU. Thus, if the LCU lacks non-zero transform coefficients (“no” 503), then entropy decoding unit 52 avoids decoding any syntax elements for delta QP (506). However, if the LCU includes non-zero transform coefficients (“yes” 503), then entropy decoding unit 52 decodes syntax elements for delta QP (504) and forwards the delta QP value to inverse quantization unit 56. In this later case, video decoder 60 decodes the transform coefficients (505), which may include inverse quantization unit 56 applying the delta QP that was included in the bitstream so as to inverse quantize the transform coefficients.

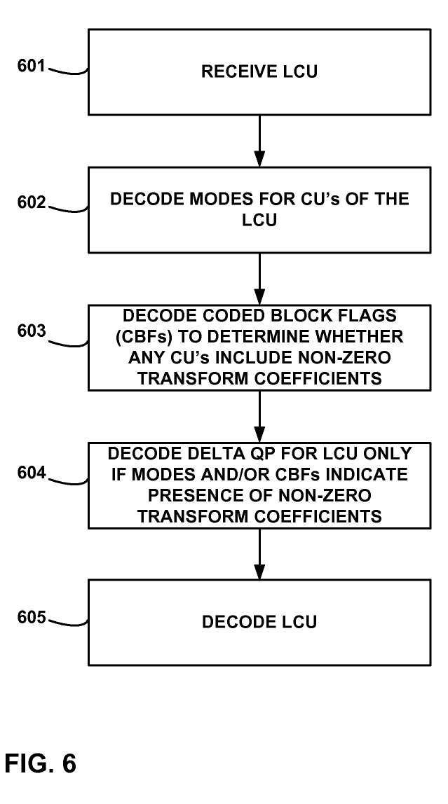

FIG. 6 is another flow diagram illustrating a decoding technique consistent with this disclosure. FIG. 6 will be described from the perspective of video decoder 60 of FIG. 4, although other devices may perform similar techniques. As shown in FIG. 6, entropy decoding unit 52 receives an LCU (601). Entropy decoding unit 52 decodes modes of CUs within the LCU (602) and decodes coded block flags (CBFs) to determine whether CU's include residual data (603). Steps 602 and 603 could also be reversed. Also, step 603 may be skipped in a case where the coding mode determined in step 602 indicates that no non-zero transform coefficients exist, which may be the case for SKIP mode. Essentially, steps 602 and 603 may comprise parsing of LCU syntax information so as to define the mode and the CBFs. At this point, entropy decoding unit 52 decodes a delta QP for the LCU only if either the coding modes of the CU's (or the entire LCU) or the CBFs indicate the presence of non-zero transform coefficients (604). Again, the absence of any non-zero transform coefficients can be identified when all of the CBF flags are set to indicate that no residual data exists, or if all of the coding modes used for the LCU are modes that lack non-zero transform coefficients (such as SKIP mode). Decoder 60 then decodes the LCU (605), which may include inverse quantization unit 56 applying the delta QP to define the QP for inverse quantization, but only in the case where the delta QP is present for the LCU.

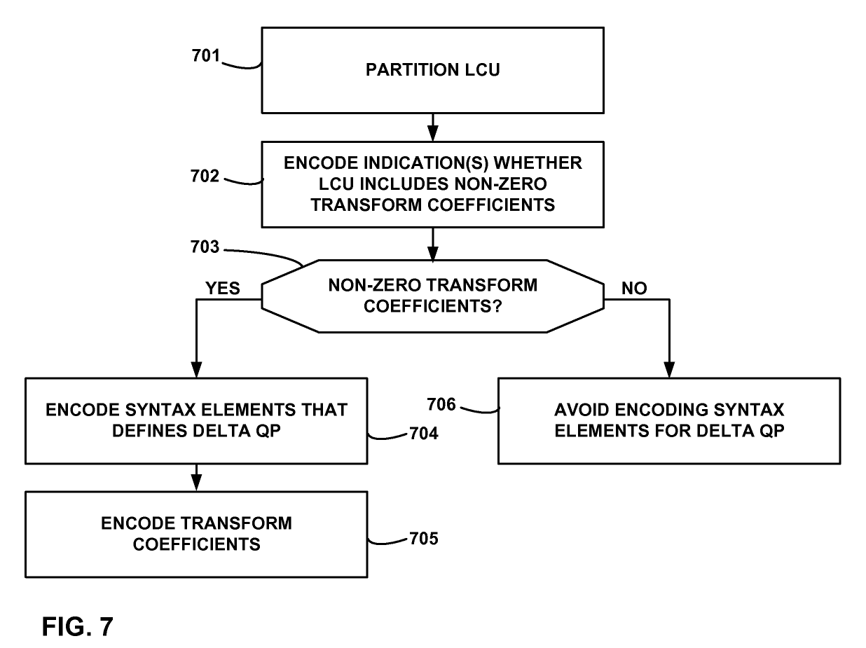

FIG. 7 is a flow diagram illustrating an encoding technique consistent with this disclosure. FIG. 7 will be described from the perspective of video encoder 50 of FIG. 3, although other devices may perform similar techniques. As shown in FIG. 7, quadtree partition unit 31 partitions an LCU (701). In particular, quadtree partition unit 31 may break an LCU into smaller CU's and PU's according to HEVC partitioning explained above with reference to FIG. 2. Encoder 50 encodes one or more indications of whether the LCU includes non-zero transform coefficients (702). In particular, prediction module 32 and/or quadtree partition unit 31 may select and encode the encoding modes for the CUs of the LCU, which may indicate whether residual data may be present for that coding mode. Also, prediction module 32 and/or quadtree partition unit 31 may interact with transform unit 38 to generate a CBFs for the LCU, which for some coding modes, indicates whether any CUs of the LCU include non-zero transform coefficients. All of this information may be entropy coded by entropy coding unit 46.

If non-zero transform coefficients exist for the LCU (“yes” 703), then encoder 50 encodes syntax that defines a delta QP (704), which may be used by quantization unit 40 and inverse quantization unit 42 to define the QP for the LCU relative to a predicted QP for that LCU. Like other syntax information, this syntax that defines a delta QP may be entropy coded by entropy encoding unit 46. Transform coefficients themselves are encoded (705) after this determination of whether non-zero transform coefficients exist for the LCU (703). Therefore, if non-zero transform coefficients do not exist for the LCU (“no” 703), then encoder 50 avoids encoding syntax that defines a delta QP (706). In this case, the corresponding video decoder (e.g., decoder 60 of FIG. 4) can be configured to know that any LCU that lacks non-zero transform coefficients also lacks any delta QP, and therefore, the decoder can parse the bitstream accordingly.

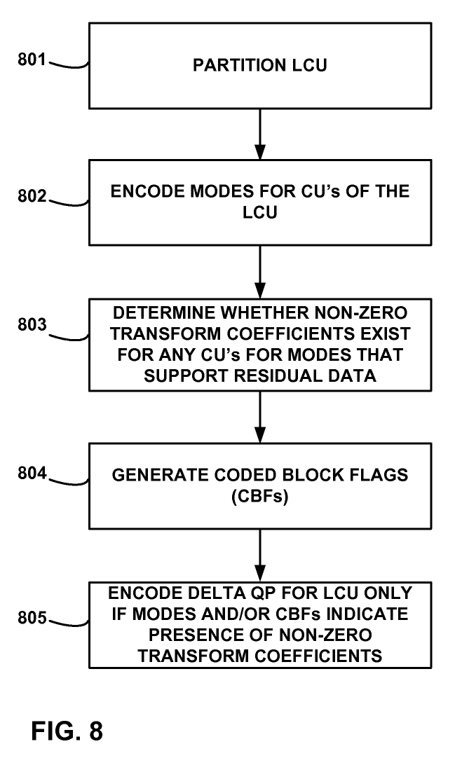

FIG. 8 is another flow diagram illustrating an encoding technique consistent with this disclosure. FIG. 8 will be described from the perspective of video encoder 50 of FIG. 3, although other devices may perform similar techniques. As shown in FIG. 8, quadtree partition unit 31 partitions an LCU (801). In particular, quadtree partition unit 31 may break an LCU into smaller CU's and PU's according to HEVC partitioning explained above with reference to FIG. 2. Prediction module 32 selects and encodes modes for the CUs of the LCU (802). As part of the encoding process, prediction module 32 may also determine whether non-zero transform coefficients exist for any CUs encoded in modes that could support residual data (803). Then, prediction module 32 and/or quadtree partition unit 31 may interact with transform unit 38 to generate CBFs for the LCU (804), which for some coding modes, indicate whether any CUs of the LCU include non-zero transform coefficients. All of this information may be entropy coded by entropy coding unit 46. A delta QP is defined (and encoded by entropy coding unit 46) only if the modes of the CUs of the LCU and/or the CBFs for the LCU indicates the presence of residual data (805).

Although FIGS. 5-8 generally illustrate the ordering of the encoding and the decoding, this disclosure more generally describes the ordering of syntax elements within an encoded bitstream. For example, as mentioned, this disclosure describes a bitstream that includes one or more syntax elements for the CU to indicate a change in a quantization parameter for the CU relative to a predicted quantization parameter for the CU only if the CU includes any non-zero transform coefficients. Moreover, this disclosure describes the placement of the one or more syntax elements after an indication that the CU will include at least some non-zero transform coefficients, and before the transform coefficients for the CU.

In still other examples, this disclosure contemplates a computer readable medium comprising a data structure stored thereon, wherein the data structure includes an encoded bitstream consistent with this disclosure. In particular, the encoded bitstream may include one or more syntax elements for the CU to indicate a change in a quantization parameter for the CU relative to a predicted quantization parameter for the CU only if the CU includes any non-zero transform coefficients, and the one or more syntax elements may be excluded from the bitstream for the CU if the CU does not include any non-zero transform coefficients. If present, the one or more syntax elements may be positioned within the encoded bitstream after an indication that the CU will include at least some non-zero transform coefficients, and before the transform coefficients for the CU.

The techniques of this disclosure may be realized in a wide variety of devices or apparatuses, including a wireless handset, and integrated circuit (IC) or a set of ICs (i.e., a chip set). Any components, modules or units have been described provided to emphasize functional aspects and does not necessarily require realization by different hardware units.

Accordingly, the techniques described herein may be implemented in hardware, software, firmware, or any combination thereof. Any features described as modules or components may be implemented together in an integrated logic device or separately as discrete but interoperable logic devices. If implemented in software, the techniques may be realized at least in part by a computer-readable medium comprising instructions that, when executed, performs one or more of the methods described above. The computer-readable data storage medium may form part of a computer program product, which may include packaging materials.

The computer-readable media described above may comprise a tangible computer readable storage medium, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates code in the form of instructions or data structures and that can be accessed, read, and/or executed by a computer.

The instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. The term “processor,” as used herein may refer to any of the foregoing structure or any other structure suitable for implementation of the techniques described herein. In addition, in some aspects, the functionality described herein may be provided within dedicated software modules or hardware modules configured for encoding and decoding, or incorporated in a combined video encoder-decoder (CODEC). Also, the techniques could be fully implemented in one or more circuits or logic elements.

Various aspects of the disclosure have been described. Although this disclosure has been primarily with respect to delta QP signaling at the LCU level, the techniques may also be applicable to cases where the delta QP is determined, encoded and sent for smaller CUs, e.g., sized large enough that quantization changes are allowed and/or supported. These and other aspects are within the scope of the following claims.

1. A method of decoding video data, the method comprising:
receiving a coding unit (CU) of encoded video data, wherein the CU is partitioned into a set of block-sized coded units (CUs) according to a quadtree partitioning scheme; and
decoding one or more syntax elements for the CU to indicate a change in a quantization parameter for the CU relative to a predicted quantization parameter for the CU only if the CU includes any non-zero transform coefficients, wherein the one or more syntax elements are decoded from a position within the encoded video data:
a) after an indication that the CU will include at least some non-zero transform coefficients, and
b) before the transform coefficients for the CU, and
wherein the one or more syntax elements are not included with the CU if the CU does not include any non-zero transform coefficients.

2. The method of claim 1, wherein the CU comprises a largest coded unit (LCU) partitioned into the set of block-sized CUs according to the quadtree partitioning scheme.

3. The method of claim 1, wherein the CU comprises a CU that is smaller than a largest coded unit (LCU), wherein the CU meets or exceeds a threshold size at which quantization changes are allowed.

4. The method of claim 1, further comprising:
decoding a first LCU and one or more syntax elements associated with the first LCU to indicate a change in a quantization parameter for the first LCU relative to the predicted quantization parameter the first LCU; and
decoding a second LCU, wherein the one or more syntax elements are not included with the second LCU because the second LCU does not include any non-zero transform coefficients.

5. The method of claim 1, wherein the one or more syntax elements comprises a delta quantization parameter indicating the change in the quantization parameter relative to the predicted quantization parameter for the CU.

6. The method of claim 1, wherein the CU comprises an LCU and the one or more syntax elements are decoded from a position within the encoded video data:
a) after one or more coded block flags (CBFs) for the LCU, wherein the CBFs define whether the CUs of the LCU include non-zero transform coefficients; and
b) before any transform coefficients of the CUs of the LCU.

7. The method of claim 6, wherein the one or more syntax elements are decoded from a position within the encoded video data that occurs after one or more syntax elements that define coding modes associated with the CUs of the LCU.

8. A method of encoding video data, the method comprising:
determining a change in a quantization parameter for a coding unit (CU) of encoded video data relative to a predicted quantization parameter for the CU, wherein the CU is partitioned into a set of block-sized coded units (CUs) according to a quadtree partitioning scheme; and
encoding one or more syntax elements for the CU to indicate the change in the quantization parameter only if the CU includes any non-zero transform coefficients, wherein the one or more syntax elements are encoded in a bitstream:
a) after an indication that the CU will include at least some non-zero transform coefficients, and
b) before the transform coefficients for the CU, and
wherein encoding the one or more syntax elements is avoided if the CU does not include any transform coefficients.

9. The method of claim 8, wherein the CU comprises a largest coded unit (LCU) partitioned into the set of block-sized CUs according to the quadtree partitioning scheme.

10. The method of claim 8, wherein the CU comprises a CU that is smaller than a largest coded unit (LCU), wherein the CU meets or exceeds a threshold size at which quantization changes are allowed.

11. The method of claim 8, wherein the one or more syntax elements comprises a delta quantization parameter indicating the change in the quantization parameter relative to the predicted quantization parameter.

12. The method of claim 8, wherein the one or more syntax elements are encoded in the bitstream before any of the transform coefficients for the CU.

13. The method of claim 8, wherein the CU comprises an LCU and the one or more syntax elements are encoded in the bitstream:
a) after one or more coded block flags (CBFs) for the LCU, wherein the CBFs define whether the CUs of the LCU include non-zero transform coefficients; and
b) before any transform coefficients of the CUs of the LCU.

14. The method of claim 13, wherein the one or more syntax elements are encoded in the bitstream after one or more syntax elements that define encoding modes associated with the CUs of the LCU.

15. The method of claim 8, wherein the CU comprises an LCU, further comprising encoding the one or more syntax elements once per LCU that includes non-zero transform coefficients.

16. A video decoding device that decodes video data, the video decoding device comprising:
a video decoder that:
receives a coding unit (CU) of encoded video data, wherein the CU is partitioned into a set of block-sized coded units (CUs) according to a quadtree partitioning scheme; and
decodes one or more syntax elements for the CU to indicate a change in a quantization parameter for the CU relative to a predicted quantization parameter for the CU only if the CU includes any non-zero transform coefficients, wherein the one or more syntax elements are decoded from a position within the encoded video data:
a) after an indication that the CU will include at least some non-zero transform coefficients, and
b) before the transform coefficients for the CU, and
wherein the one or more syntax elements are not included with the CU if the CU does not include any non-zero transform coefficients.

17. The video decoding device of claim 16, wherein the CU comprises a largest coded unit (LCU) partitioned into the set of block-sized CUs according to the quadtree partitioning scheme.

18. The video decoding device of claim 16, wherein the CU comprises a CU that is smaller than a largest coded unit (LCU), wherein the CU meets or exceeds a threshold size at which quantization changes are allowed.

19. The video decoding device of claim 16, wherein the video decoder:
decodes a first LCU and one or more syntax elements associated with the first LCU to indicate a change in a quantization parameter for the first LCU relative to the predicted quantization parameter the first LCU; and
decodes a second LCU, wherein the one or more syntax elements are not included with the second LCU because the second LCU does not include any non-zero transform coefficients.

20. The video decoding device of claim 16, wherein the one or more syntax elements comprises a delta quantization parameter indicating the change in the quantization parameter relative to the predicted quantization parameter for the CU.

21. The video decoding device of claim 16, wherein the CU comprises an LCU and the one or more syntax elements are decoded from a position within the encoded video data:
a) after one or more coded block flags (CBFs) for the LCU, wherein the CBFs define whether the CUs of the LCU include non-zero transform coefficients; and
b) before any transform coefficients of the CUs of the LCU.

22. The video decoding device of claim 21, wherein the one or more syntax elements are decoded from a position within the encoded video data that occurs after one or more syntax elements that define coding modes associated with the CUs of the LCU.

23. The video decoding device of claim 16, wherein the video decoding device comprises one or more of:
an integrated circuit;
a microprocessor; and
a wireless communication device that includes a video decoder.

24. A video encoding device that encodes video data, the video encoding device comprising:
a video encoder that:
determines a change in a quantization parameter for a coding unit (CU) of encoded video data relative to a predicted quantization parameter for the CU, wherein the CU is partitioned into a set of block-sized coded units (CUs) according to a quadtree partitioning scheme; and
encodes one or more syntax elements for the CU to indicate the change in the quantization parameter only if the CU includes any non-zero transform coefficients, wherein the one or more syntax elements are encoded in a bitstream:
a) after an indication that the CU will include at least some non-zero transform coefficients, and
b) before the transform coefficients for the CU, and
wherein encoding the one or more syntax elements is avoided if the CU does not include any transform coefficients.

25. The video encoding device of claim 24, wherein the CU comprises a largest coded unit (LCU) partitioned into the set of block-sized CUs according to the quadtree partitioning scheme.

26. The video encoding device of claim 24, wherein the CU comprises a CU that is smaller than a largest coded unit (LCU), wherein the CU meets or exceeds a threshold size at which quantization changes are allowed.

27. The video encoding device of claim 24, wherein the one or more syntax elements comprises a delta quantization parameter indicating the change in the quantization parameter relative to the predicted quantization parameter.

28. The video encoding device of claim 24, wherein the one or more syntax elements are encoded in the bitstream before any of the transform coefficients for the CU.

29. The video encoding device of claim 24, wherein the CU comprises an LCU and the one or more syntax elements are encoded in the bitstream:
a) after one or more coded block flags (CBFs) for the LCU, wherein the CBFs define whether the CUs of the LCU include non-zero transform coefficients; and
b) before any transform coefficients of the CUs of the LCU.

30. The video encoding device of claim 29, wherein the one or more syntax elements are encoded in the bitstream after one or more syntax elements that define encoding modes associated with the CUs of the LCU.

31. The video encoding device of claim 24, wherein the CU comprises an LCU, wherein the video encoder encodes the one or more syntax elements once per LCU that includes non-zero transform coefficients.

32. The video encoding device of claim 24, wherein the video encoding device comprises one or more of:
an integrated circuit;
a microprocessor; and
a wireless communication device that includes a video encoder.

33. A device for decoding video data, the device comprising:
means for receiving a coding unit (CU) of encoded video data, wherein the CU is partitioned into a set of block-sized coded units (CUs) according to a quadtree partitioning scheme; and
means for decoding one or more syntax elements for the CU to indicate a change in a quantization parameter for the CU relative to a predicted quantization parameter for the CU only if the CU includes any non-zero transform coefficients, wherein the one or more syntax elements are decoded from a position within the encoded video data:
a) after an indication that the CU will include at least some non-zero transform coefficients, and
b) before the transform coefficients for the CU, and
wherein the one or more syntax elements are not included with the CU if the CU does not include any non-zero transform coefficients.

34. The device of claim 33, wherein the CU comprises one of:
a largest coded unit (LCU) partitioned into the set of block-sized CUs according to the quadtree partitioning scheme.
a CU that is smaller than the LCU, wherein the CU meets or exceeds a threshold size at which quantization changes are allowed.

35. The device of claim 33, wherein the CU comprises an LCU and the one or more syntax elements are decoded from a position within the encoded video data:
a) after at least one coded block flag (CBF) for the LCU;
b) before any transform coefficients for the LCU; and
c) after encoding modes associated with the CUs of the LCU.

36. A device for encoding video data, the device comprising:
means for determining a change in a quantization parameter for a coding unit (CU) of encoded video data relative to a predicted quantization parameter for the CU, wherein the CU is partitioned into a set of block-sized coded units (CUs) according to a quadtree partitioning scheme; and
means for encoding one or more syntax elements for the CU to indicate the change in the quantization parameter only if the CU includes any non-zero transform coefficients, wherein the one or more syntax elements are encoded in a bitstream:
a) after an indication that the CU will include at least some non-zero transform coefficients, and
b) before the transform coefficients for the CU, and
wherein the means for encoding avoids encoding the one or more syntax elements if the CU does not include any transform coefficients.

37. The device of claim 36, wherein the CU comprises one of:
a largest coded unit (LCU) partitioned into the set of block-sized CUs according to the quadtree partitioning scheme; and
a CU that is smaller than the LCU, wherein the CU meets or exceeds a threshold size at which quantization changes are allowed.

38. The device of claim 36, wherein the CU comprises an LCU and the means for encoding the one or more syntax elements encodes the one or more syntax elements in the encoded bitstream:
a) after at least one coded block flag (CBF) for the LCU;
b) before any transform coefficients for the LCU; and
c) after syntax elements that define encoding modes associated with the CUs of the LCU.

39. A computer-readable medium comprising instructions that upon execution cause a processor to decode video data, wherein the instructions cause the processor to:
upon receiving a coding unit (CU) of encoded video data, wherein the CU is partitioned into a set of block-sized coded units (CUs) according to a quadtree partitioning scheme;
decode one or more syntax elements for the CU to indicate a change in a quantization parameter for the CU relative to a predicted quantization parameter for the CU only if the CU includes any non-zero transform coefficients, wherein the one or more syntax elements are decoded from a position within the encoded video data:
a) after an indication that the CU will include at least some non-zero transform coefficients, and
b) before the transform coefficients for the CU, and
wherein the one or more syntax elements are not included with the CU if the CU does not include any non-zero transform coefficients.

40. The computer-readable medium of claim 39, wherein the CU comprises one of:
a largest coded unit (LCU) partitioned into the set of block-sized CUs according to the quadtree partitioning scheme.
a CU that is smaller than the LCU, wherein the CU meets or exceeds a threshold size at which quantization changes are allowed.

41. The computer-readable medium of claim 39, wherein the CU comprises an LCU and the one or more syntax elements are decoded from a position within the encoded video data:
a) after at least one coded block flag (CBF) for the LCU;
b) before any transform coefficients for the LCU; and
c) after one or more syntax elements that define encoding modes associated with the CUs of the LCU.

42. A computer-readable medium comprising instructions that upon execution cause a processor to encode video data, wherein the instructions cause the processor to:
determine a change in a quantization parameter for a coding unit (CU) of encoded video data relative to a predicted quantization parameter for the CU, wherein the CU is partitioned into a set of block-sized coded units (CUs) according to a quadtree partitioning scheme; and
encode one or more syntax elements for the CU to indicate the change in the quantization parameter only if the CU includes any non-zero transform coefficients, wherein the one or more syntax elements are encoded in a bitstream:
a) after an indication that the CU will include at least some non-zero transform coefficients, and
b) before the transform coefficients for the CU, and
wherein the instructions cause the processor to avoid encoding the one or more syntax elements if the CU does not include any transform coefficients.

43. The computer-readable medium of claim 42, wherein the CU comprises one of:
a largest coded unit (LCU) partitioned into the set of block-sized CUs according to the quadtree partitioning scheme.
a CU that is smaller than the LCU, wherein the CU meets or exceeds a threshold size at which quantization changes are allowed.

44. The computer-readable medium of claim 42, wherein the CU comprises an LCU and the instructions cause the processor to encode the one or more syntax elements in the encoded bitstream:
a) after at least one coded block flag (CBF) for the LCU;
b) before any transform coefficients for the LCU; and
c) after one or more syntax elements that define encoding modes associated with the CUs of the LCU.
